(19) United States
(12) Patent Application Publication
(10) Pub. No.: US 2023/0094479 A1
(43) Pub. Date: Mar. 30, 2023

(54) Machine Learning Regression Analysis

(71) Applicant: Google LLC, Mountain View, CA (US)

(72) Inventors: Xi Cheng, Kirkland, WA (US); Lisa Yin, Redmond, WA (US); Mingge Deng, Kirkland, WA (US); Amir Hormati, Mountain View, CA (US); Umar Ali Syed, Edison, NJ (US); Jiashang Liu, Mountain View, CA (US)

(73) Assignee: Google LLC, Mountain View, CA (US)

(21) Appl. No.: 17/449,660

(22) Filed: Sep. 30, 2021

(51) Int. Cl. G06N 7/00; G06K 9/62

(52) U.S. Cl. CPC G06N 7/005; G06K 9/6256; G06K 9/6263

(57) ABSTRACT

A method includes receiving a model analysis request from a user. The model analysis requests requesting the data processing hardware to provide one or more statistics of a model trained on a dataset. The method also includes obtaining the trained model. The trained model includes a plurality of weights. Each weight is assigned to a feature of the trained model. The model also includes determining, using the dataset and the plurality of weights, the one or more statistics of the trained model based on a linear regression of the trained model. The method includes reporting the one or more statistics of the trained model to the user.

### TECHNICAL FIELD

This disclosure relates to machine learning regression analysis.

### BACKGROUND

Machine learning is an attempt to understand data using mathematical models. It is often advantageous to determine a quality of these mathematical models or how the mathematical model is making decisions. Regression analysis is often used to determine relationships between dependent variables and independent variables. Regression analysis can thus be used to answer questions about the dependence of a response variable on one or more predictors for a model, including prediction of future values of a response, discovering which predictors are important, and estimating the impact of changing a predictor or a treatment on the value of the response.

### SUMMARY

One aspect of the disclosure provides a computer-implemented method that when executed by data processing hardware causes the data processing hardware to perform operations. The operations include receiving a model analysis request from a user. The model analysis request requests the data processing hardware to provide one or more statistics of a model trained on a dataset. The method also includes obtaining the trained model. The trained model includes a plurality of weights. Each weight of the plurality of weights is assigned to a feature of the trained model. The method includes determining, using the dataset and the plurality of weights, the one or more statistics of the trained model based on a linear regression of the trained model. The method includes reporting the one or more statistics of the trained model to the user.

Implementations of the disclosure may include one or more of the following optional features. In some implementations, the dataset includes a database stored on a cloud database in communication with the data processing hardware. Obtaining the trained model may include retrieving the dataset and training the model using the dataset.

In some examples, determining the one or more statistics of the trained model based on the linear regression of the trained model includes determining, using the dataset and the plurality of weights, an information matrix. These examples may further include determining an inverse of the information matrix. The information matrix may include a Fisher information matrix.

Optionally, the one or more statistics includes p-values. The one or more statistics may include standard error values. In some implementations, the model analysis request includes a single Structured Query Language (SQL) query. The trained model may be trained on the dataset after the dataset is standardized. In these examples, the operations may further include, before reporting the one or more statistics of the trained model to the user, updating the one or more statistics based on an unstandardized form of the dataset.

Another aspect of the disclosure provides data processing hardware and memory hardware in communication with the data processing hardware. The memory hardware stores instructions that when executed on the data processing hardware cause the data processing hardware to perform operations. The operations include receiving a model analysis request from a user. The model analysis request requests the data processing hardware to provide one or more statistics of a model trained on a dataset. The method also includes obtaining the trained model. The trained model includes a plurality of weights. Each weight of the plurality of weights is assigned to a feature of the trained model. The method includes determining, using the dataset and the plurality of weights, the one or more statistics of the trained model based on a linear regression of the trained model. The method includes reporting the one or more statistics of the trained model to the user.

This aspect may include one or more of the following optional features. In some implementations, the dataset includes a database stored on a cloud database in communication with the data processing hardware. Obtaining the trained model may include retrieving the dataset and training the model using the dataset.

In some examples, determining the one or more statistics of the trained model based on the linear regression of the trained model includes determining, using the dataset and the plurality of weights, an information matrix. These examples may further include determining an inverse of the information matrix. The information matrix may include a Fisher information matrix.

Optionally, the one or more statistics includes p-values. The one or more statistics may include standard error values. In some implementations, the model analysis request includes a single Structured Query Language (SQL) query. The trained model may be trained on the dataset after the dataset is standardized. In these examples, the operations may further include, before reporting the one or more statistics of the trained model to the user, updating the one or more statistics based on an unstandardized form of the dataset.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for using regression analysis to evaluate machine learning models.

FIG. 2 is a schematic view of exemplary components of a model analyzer of the system of FIG. 1.

FIG. 3 is a schematic view of exemplary components of a regression analyzer of the system of FIG. 1.

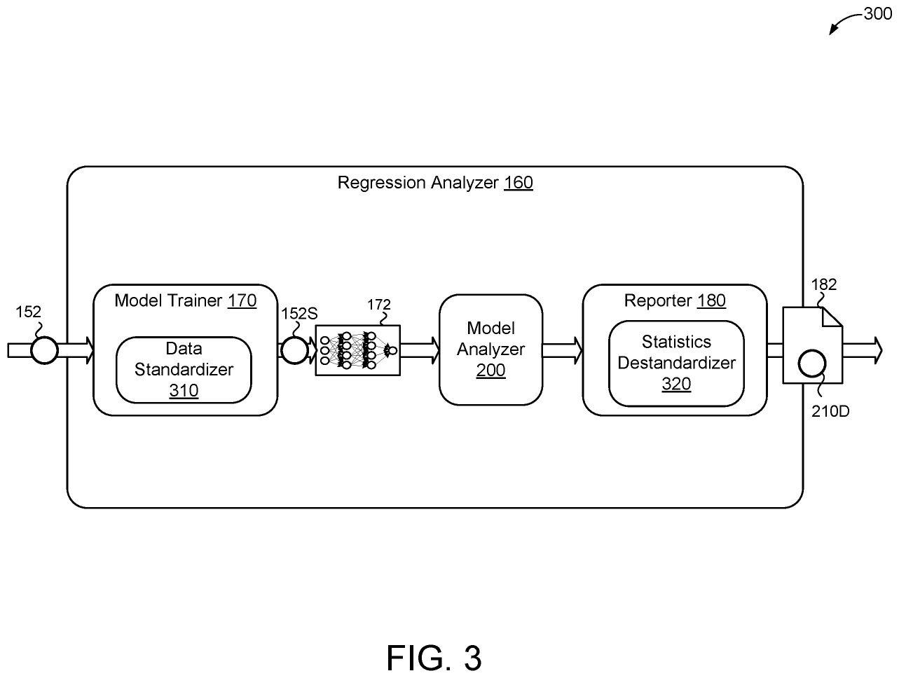

FIG. 4 is a flowchart of an example arrangement of operations for a method of using regression analysis to evaluate machine learning models.

FIG. 5 is a schematic view of an example computing device that may be used to implement the systems and methods described herein.

Like reference symbols in the various drawings indicate like elements.

### DETAILED DESCRIPTION

Machine learning is an attempt to understand data via mathematical models. After some types of models are trained (e.g., linear models and logistic regression models), regression analysis may be used to examine weights assigned to each feature of the model to help inform how the model makes decisions. Regression analysis answers questions about the dependence of a response variable on one or more predictors, including prediction of future values of a response, discovering which predictors are important, and estimating the impact of changing a predictor or a treatment on the value of the response.

Generalized linear models (GLMs) are a broad category of machine learning models that encompass both linear and logistic regression models. A GLM is made up of a linear predictor, a link function that describes how the mean depends on the linear predictor, and a variance function that describes how the variance depends on the mean. Both logistic and linear regression models may be trained using a gradient descent method by leveraging the fact that the models both belong to the same family of problems.

Regression analysis may derive statistics such as standard error values and/or p-values. P-values may be used to determine statistical significance in a hypothesis test which helps determine how likely results from a model can be attributed to chance. This often involves making null and alternative hypotheses. The null and alternative hypotheses must be mutually exclusive in that, if the null hypothesis is not valid, then it will be rejected and the alternative hypothesis will be valid. An alpha value is determined by a user as a threshold at which a p-value is compared against to reject or fail to reject the null hypothesis. When the p-value is less than the alpha value, then the null hypothesis is rejected. The alpha value is determined by the particular use case but often is either 0.01 or 0.05. Given a sufficiently low enough p-value compared to the alpha value, a model analyzer can determine whether or not to reject the null hypothesis and thus conclude that the weights of the model have a statistically significant chance of not being zero. When the p-value for the weight is too large, then the null hypothesis cannot be rejected and thus there is a statistically significant chance that the weight calculated was due to random noise.

Implementations herein are directed toward a regression analyzer capable of large-scale regression analysis within cloud database systems. The analyzer includes, in some implementations, a Structured Query Language (SQL) interface that is capable of handling a database of near unlimited number of rows (i.e., a database that is larger than a single computer can store) with each row having up to hundreds of thousands of features. The system includes solutions to perform regression analysis on feature coefficients and intercepts when features are standardized prior to fitting, as feature standardization typically greatly accelerates convergence of model fitting. In some examples, the system performs large-scale matrix inversion to efficiently analyze target models and provides a fully managed cloud database service with full orchestration without attention required from users.

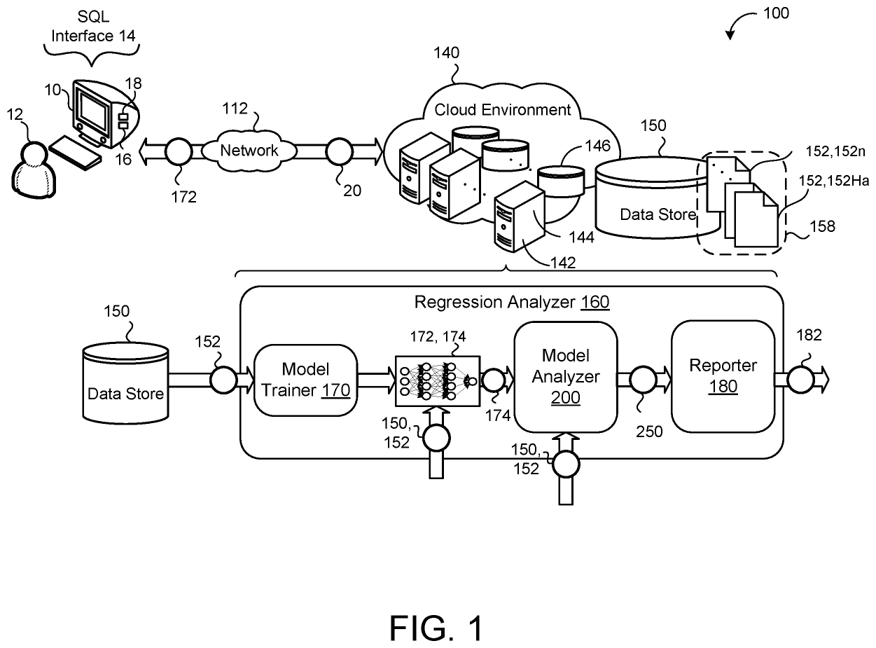

Referring to FIG. 1, in some implementations, an example point data anomaly detection system 100 includes a remote system 140 in communication with one or more user devices 10 via a network 112. The remote system 140 may be a single computer, multiple computers, or a distributed system (e.g., a cloud environment) having scalable/elastic resources 142 including computing resources 144 (e.g., data processing hardware) and/or storage resources 146 (e.g., memory hardware). A data store 150 (i.e., a remote storage device) may be overlain on the storage resources 146 to allow scalable use of the storage resources 146 by one or more of the clients (e.g., the user device 10) or the computing resources 144. The data store 150 is configured to store a plurality of data blocks 152, 152a—n within one or more tables 158, 158a—n (i.e., a cloud database). The data store 150 may store any number of tables 158 at any point in time.

The remote system 140 is configured to receive a regression analysis query 20 (i.e., a request) from a user device 10 associated with a respective user 12 via, for example, the network 112. The user device 10 may correspond to any computing device, such as a desktop workstation, a laptop workstation, or a mobile device (i.e., a smart phone). The user device 10 includes computing resources 18 (e.g., data processing hardware) and/or storage resources 16 (e.g., memory hardware). The user 12 may construct the query 20 using a Structured Query Language (SQL) interface 14. Each regression analysis query 20 requests the remote system 140 to determine, using regression analysis, one or more statistics 250 of a trained model 172.

In some implementations, the regression analyzer 160 includes a model trainer 170. The model trainer 170 generates and trains one or more models 172. In some examples, the model 172 is a linear model or a logistic regression model. The model trainer 170 may train the model 172 on data values 152 (also referred to herein as data blocks or features) retrieved from one or more tables 158 stored on the data store 150 that are associated with the user 12. Alternatively, the query 20 may include the data 152. In this case, the user 12 (via the user device 10) may provide the data 152 when the data 152 (i.e., features) is not otherwise available via the data storage 150. In some examples, the data values 152 are stored in databases (e.g., with multiple columns and/or multiple rows). The model trainer 170 may train the model 172 based on parameters received from the user 12. In other examples, the regression analyzer 160 obtains the trained model 172 from other sources (e.g., from the user device 10).

The dataset used to train the model 172 (e.g., one or more tables 158) includes a number of features 152. A feature represents an attribute and value combination. For example, when “color” is an attribute, “color is red” may be a feature. In some examples, each column in the table(s) 158 corresponds to a different feature 152. The model 172 may be trained on any number of features 152 (e.g., hundreds of thousands of features). For example, a table 158 with thousands of columns corresponds to thousands of features 152, each of which may be used to train the model 172. The trained model 172 includes multiple weights 174. Each weight 174 corresponds to or is assigned to one of the features 152. Each weight 174 represents an amount of influence the model 172 places on the associated feature 152 (i.e., a coefficient for the feature 152). The table(s) 158 may be part of a cloud or distributed database storage system.

The regression analyzer 160 includes a model analyzer 200. The model analyzer 200 receives the trained model 172 (e.g., from the model trainer 170 or from some other remote source). The model analyzer 200, as described in more detail below, uses regression analysis (e.g., linear regression) to determine one or more statistics 250 of the trained model 172. A reporter module 180 receives the one or more statistics 250 and reports the statistics 250 to the user 12 by, for example, generating a report 182 that includes the statistics 250 and communicating the report 182 to the user device 10. The report 182, in some examples, includes a table with each row including a respective feature 152 and the associated weight 174 and one or more statistics 250 (e.g., a standard error value, a p-value, etc.) for that feature 152.

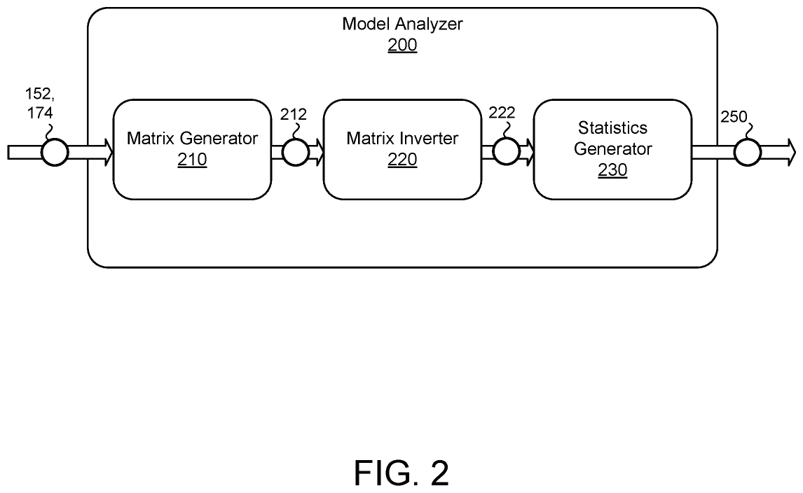

Referring now to FIG. 2, in some implementations, the model analyzer 200 includes a matrix generator 210. The matrix generator 210, using the dataset (i.e., features 152) and the weights 174, determines or generates an information matrix 212. In some examples, the information matrix 212 includes a Fisher information matrix 212. The Fisher information matrix 212 represents a variance of an expected value of the dataset. That is, the Fisher information matrix 212 includes Fisher information which may be used to measure an amount of information in an observable variable (i.e., the features 152) carries regarding an unknown parameter upon which the probability of the observable behavior depends.

In some examples, the model analyzer 200 includes a matrix inverter 220. The matrix inverter 220 receives the information matrix 212 and inverts the information matrix 212 to generate an inverted matrix 222. The matrix inverter 220 may use, for example, Newton's method for matrix inversion. In other examples, the matrix inverter 220 may determine a Neumann series to provide a good asymptotic approximation.

Conventionally, determining the inverted matrix 222 (e.g., of the Fisher information matrix 212) requires the entire matrix 212 to fit inside memory of a single machine (e.g., a single server or equivalent). However, due to the size of some cloud databases, this may not be possible. When the information matrix 212 is of sufficient size that the entire matrix 212 cannot feasibly fit into memory of a single machine, the matrix inverter 220 may use a truncated iterative method of inverting matrices implemented in, for example, SQL. For example, the matrix inverter 220 combines the Newton method and the Neumann series.

A statistics generator 230 determines or derives the model statistics 250 via the inverted matrix 222. For example, the model statistics 250 include standard error values and/or p-values. The statistics generator 230 may determine the standard error values via determining a square root of a diagonal of the inverted matrix 222. The statistics generator 230 may derive the p-values directly from the standard error values.

Referring now to FIG. 0.3, the model trainer 170 trains the model 172 on standardized features 152S. In regression analysis, it is often highly recommended to standardize independent variables (i.e., features) to help convergence when model fitting. Data standardization of a variable may include determining a mean and a standard deviation of a variable. To standardize a particular variable, the variable is reduced by the mean and then divided by the standard deviation. In schematic view 300, the regression analyzer 160 includes a data standardizer 310 that receives the features 152 and standardizes each feature 152 prior to training the model 172 (e.g., using the mean and standard deviation of the respective feature 152). The model trainer 170 then trains the model 172 using standardized features 152S.

It is important to note, however, that data standardization, while improving convergence, generally affects (for ordinary least squares) coefficient estimates and standard errors. Generally, p-values remain the same except for p-values associated with the intercept coefficient. In some use cases, it is desirable for the user 12 to obtain statistics 250 based on unstandardized data. That is, the user may only be interested in coefficients of raw input data (i.e., unstandardized data). Thus, it is advantageous to “destandardize” (i.e., convert) the statistics 250 to a format the represents unstandardized data.

In some examples, the regression analyzer 160 includes a statistics destandardizer 320. The reporter 180, via the statistics destandardizer 320, before reporting the one or more statistics 250 of the trained model 172 to the user 12, may update the one or more statistics 250 based on an unstandardized form of the dataset 152. The statistics destandardizer 320 receives the one or more statistics 250 generated from the trained model 172 trained on standardized features 152S. The statistic destandardizer 320 destandardizes the statistics 250 so that the destandardized statistics 210D reflect statistics generated from a model trained on similar unstandardized data. In some examples, the statistics destandardizer 320 destandardizes one or more of coefficient estimates, standard error values, and/or p-values.

For example, the statistics destandardizer 320, for non-intercept coefficients, may divide each coefficient by the standard deviation of the respective independent variable. For intercept coefficients, the statistics destandardizer 320 may determine (using the standardized coefficients, the sample mean, and the standard deviation) the original coefficients. Using the original coefficients, the statistics destandardizer 320 may covert standard errors to the intercept by determining a variance and an estimated covariance matrix. Destandardized p-values may then be derived from the destandardized standard error values.

Thus, the regression analyzer 160 allows a user 12 to determine a quality or a “goodness” of a model through regression analysis techniques such as standard error and p-value statistical significance tests. The regression analyzer 160 enables the user 12 to view model statistic calculations alongside, for example, model weights. The regression analyzer 160 may calculate p-values through a Fisher information matrix which the regression analyzer determines with a combination of input data (i.e., features) and the model weights (e.g., a model weights table).

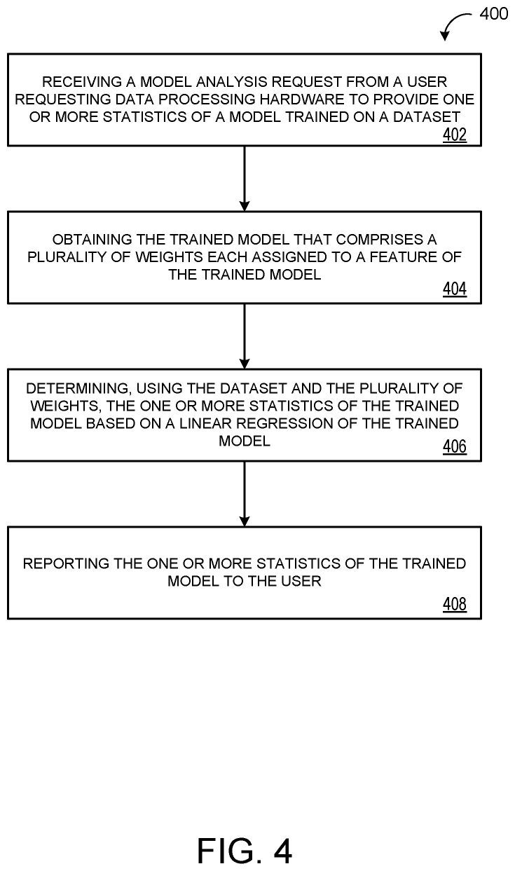

FIG. 4 is a flowchart of an exemplary arrangement of operations for a method 400 of using regression analysis to evaluate machine learning models. The method includes, at operation 402, receiving a model analysis request 20 from a user 12. The model analysis request 21 requests data processing hardware 144 to provide one or more statistics 250 of a model 172 trained on a dataset. At operation 404, the method 400 includes obtaining the trained model 172. The trained model 172 includes a plurality of weights 174. Each weight 174 is assigned to a feature 152 of the trained model 172. The method 400, at operation 406, includes determining, using the dataset 152 and the plurality of weights 174, the one or more statistics 250 of the trained model 172 based on a linear regression of the trained model 172. At operation 408, the method 400 includes reporting the one or more statistics 250 of the trained model 172 to the user 12.

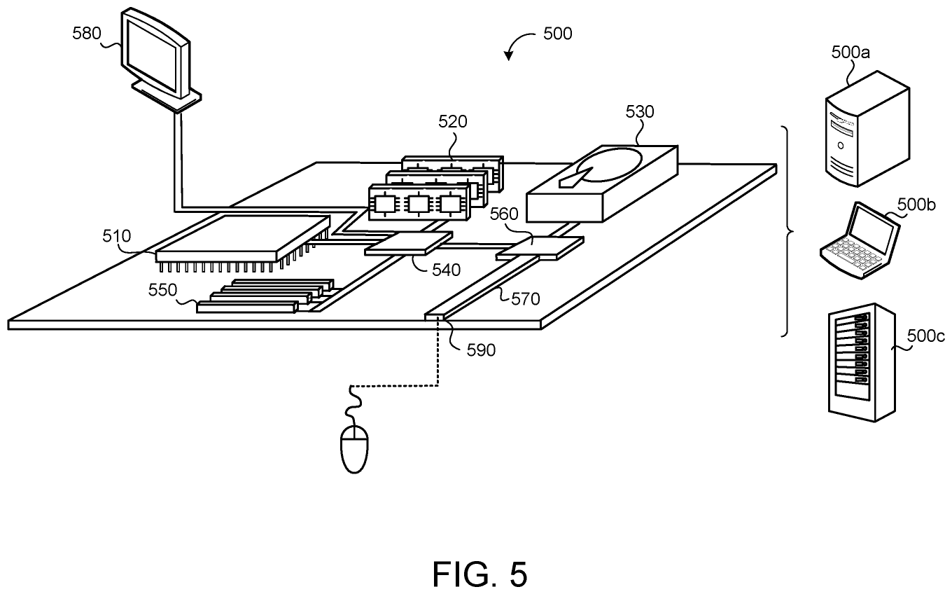

FIG. 5 is schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware causes the data processing hardware to perform operations comprising:
receiving a model analysis request from a user, the model analysis request requesting the data processing hardware to provide one or more statistics of a model trained on a dataset;
obtaining the trained model, the trained model comprising a plurality of weights, each weight of the plurality of weights assigned to a feature of the trained model;
determining, using the dataset and the plurality of weights, the one or more statistics of the trained model based on a linear regression of the trained model; and
reporting the one or more statistics of the trained model to the user.

2. The method of claim 1, wherein the dataset comprises a database stored on a cloud database in communication with the data processing hardware.

3. The method of claim 1, wherein obtaining the trained model comprises:
retrieving the dataset; and
training the model using the dataset.

4. The method of claim 1, wherein determining the one or more statistics of the trained model based on the linear regression of the trained model comprises:
determining, using the dataset and the plurality of weights, an information matrix; and
determining an inverse of the information matrix.

5. The method of claim 4, wherein the information matrix comprises a Fisher information matrix.

6. The method of claim 1, wherein the one or more statistics comprises p-values.

7. The method of claim 1, wherein the one or more statistics comprises standard error values.

8. The method of claim 1, wherein the model analysis request comprises a single Structured Query Language (SQL) query.

9. The method of claim 1, wherein the trained model is trained on the dataset after the dataset is standardized.

10. The method of claim 9, wherein the operations further comprise, before reporting the one or more statistics of the trained model to the user, updating the one or more statistics based on an unstandardized form of the dataset.

11. A system comprising:
data processing hardware; and
memory hardware in communication with the data processing hardware, the memory hardware storing instructions that when executed on the data processing hardware cause the data processing hardware to perform operations comprising:
receiving a model analysis request from a user, the model analysis request requesting the data processing hardware to provide one or more statistics of a model trained on a dataset;
obtaining the trained model, the trained model comprising a plurality of weights, each weight of the plurality of weights assigned to a feature of the trained model;
determining, using the dataset and the plurality of weights, the one or more statistics of the trained model based on a linear regression of the trained model; and
reporting the one or more statistics of the trained model to the user.

12. The system of claim 11, wherein the dataset comprises a database stored on a cloud database in communication with the data processing hardware.

13. The system of claim 11, wherein obtaining the trained model comprises:
retrieving the dataset; and
training the model using the dataset.

14. The system of claim 11, wherein determining the one or more statistics of the trained model based on the linear regression of the trained model comprises:
determining, using the dataset and the plurality of weights, an information matrix; and
determining an inverse of the information matrix.

15. The system of claim 14, wherein the information matrix comprises a Fisher information matrix.

16. The system of claim 11, wherein the one or more statistics comprises p-values.

17. The system of claim 11, wherein the one or more statistics comprises standard error values.

18. The system of claim 11, wherein the model analysis request comprises a single Structured Query Language (SQL) query.

19. The system of claim 11, wherein the trained model is trained on the dataset after the dataset is standardized.

20. The system of claim 19, wherein the operations further comprise, before reporting the one or more statistics of the trained model to the user, updating the one or more statistics based on an unstandardized form of the dataset.
